(19) United States
(12) Patent Application Publication
(10) Pub. No.: US 2006/0061858 A1
(43) Pub. Date: Mar. 23, 2006

(54) Binoculars having single objective lens

(76) Inventors: Dixiang Long, Yuyao City (CN); Fei Ying, Yuyao City (CN)

Correspondence Address: GLOBAL IP SERVICES, 2462 ROCK ST., APT. 6, MOUNTAIN VIEW, CA, 94043, US

(21) Appl. No.: 11/213,068

(22) Filed: Aug. 25, 2005

(30) Foreign Application Priority Data
Sep. 17, 2004 (CN) 200410066495.4

(51) Int. Cl. G02B 23/00; G02B 27/64

(52) U.S. Cl. 359/407; 359/422

(57) ABSTRACT

The present invention relates to a binoculars having single objective lens. A reflecting mirror transferring means comprising four planar mirrors is used to replace a reflecting mirror transferring means comprising prisms, thus the manufacture cost is greatly reduced. The angle included between two planar mirrors is particularly specified. The feature of the transferring mechanism is ingeniously used by taking a semi-transparent and semi-reflecting mirror as the first planar mirror, so that it serves both functions of image transferring and light splitting, thereby the structure of the product is greatly simplified and the component parts of the product are reduced. At the same time, a second reflecting mirror transferring means having the same structure as that of the first reflecting mirror transferring means and an eye lens are provided behind the semi-transparent, semi-reflecting mirror. Thereby Viewing an object with a binoculars having single objective lens is realized with the advantages of simple product structure, low production cost, light weight and small volume. As compared with the similar binoculars having single objective lens in which prisms are used, the manufacture cost of the invention is reduced to a tenth part, and the invention can be widely popularized.

### CROSS REFERENCE TO RELATED APPLICATION

This application claims the benefit of a Chinese patent application serial No. 200410066495.4 filed on Sep. 17, 2004.

### TECHNICAL FIELD

The present invention relates to a telescope, particularly to a binoculars having single objective lens.

### BACKGROUND ART

The existing optical telescopes are mainly used for viewing distant objects by magnifying image. There are mainly two types: monocular telescope and binoculars. A telescope generally includes objective lens, eye piece(s) and reflecting mirror transferring means arranged between them. These reflecting mirror transferring means comprise generally more than two prisms. The manufacture of his kind of reflecting mirror transferring is complex, the prism itself is heavy, and the cost of manufacture is relatively higher. In a telescope, the cost of reflecting mirror transferring means occupies a larger proportion. In daily use, because both the volume and the number of component parts of a binoculars is larger, the binoculars is heavier and has higher cost. A user prefers a monocular telescope when large aperture, long focus distance, high magnifying power observation telescopes (for example, target observation telescope, astronomical telescope etc.) are used. However, the monocular telescope has one main drawback, i.e. the single ocular structure of monocular telescope does not conform to the habit of viewing objects with both eyes. Furthermore, viewing objects with single eye causes fatigue easily when viewing time is long. Hence, people try to design a binoculars having single objective lens. For example, the Chinese utility model patent No.2, 343,600Y granted on Oct. 13, 1999 disclosed a binoculars having single objective lens, in which, behind the reflecting mirror transferring means is arranged a light splitting means having a set of prisms. Through the light splitting means the single light beam from the objective lens is split into two light beams that enter respectively the left and right eye lens. Thereby, the effect of viewing objects by a binoculars with single objective lens is the same of the effect by a binoculars. However, the structure of this kind of telescope is complex, said light splitting means comprises four prisms. Thereby the manufacture cost is largely increased, and it is unsuitable for popularization of astronomical telescopes and target observing telescopes on which there is a greater demand.

### SUMMARY OF THE INVENTION

The technical problem to be solved by the present invention is, aiming at the prior art deficiencies, to provide a binoculars having single objective lens and which is of simple structure, small volume, light weight and low production cost. The technical scheme adopted for overcoming the above-mentioned deficiency is: a binoculars having single objective lens comprises an objective lens, a first eye lens and a first reflecting mirror transferring means. Said first reflecting mirror transferring means includes a first planar mirror, a second planar mirror, a third planar mirror and a fourth planar mirror. After passing through the objective lens, the optical path is reflected successively by the first planar mirror, the second planar mirror, the third planar mirror and the fourth planar mirror and arrives at the first eye lens. The plane of incidence of the first planar mirror is perpendicular to the plane of incidence of the second planar mirror, the incidence plane of the second reflecting mirror coincides with the incidence plane of the third reflecting mirror. The incidence plane of the said third reflecting mirror is perpendicular to the incidence plane of the fourth reflecting mirror. The angle of incidence of the first reflecting mirror, the angle of incidence of the second reflecting mirror and the angle of incidence of the third reflecting mirror are all equal to 45°. The said first plane reflecting mirror is a half-transmitting, half-reflecting mirror. A second reflecting mirror transferring means is the structure of which the same as the structure of the first transferring mechanism and a second eye lens are arranged behind the first plane reflecting mirror. The light path, after arriving at the said first plane reflecting mirror, is divided into a reflected light path and a transmitted light path, said reflected light reaches at the first eye lens and said transmitted light, after passing through the second reflecting mirror transferring means, reaches at said second eye lens, and the incidence angle (angle of incidence) of the fourth plane reflecting mirror is 15°˜75°.

Preferably, the angle of incidence of the fourth plane reflecting mirror is 30°.

Said second reflecting mirror transferring means comprises the fifth plane reflecting mirror, the sixth plane reflecting mirror, the seventh reflecting mirror and the eighth plane reflecting mirror. After the transmitted light beam is successively reflected by the fifth plane reflecting mirror, the sixth plane reflecting mirror, the seventh plane reflecting mirror and the eighth plane reflecting mirror, it reaches at said second eye lens. Said fifth plane reflecting mirror is a total reflecting mirror and the angle of incidence of the eighth plane reflecting mirror has the same angle of incidence as the fourth plane reflecting mirror.

The third plane reflecting mirror and the fourth plane reflecting mirror are arranged within the first fixing means. The said first fixing means and the said first eye lens are arranged on first mobile means. Said the seventh plane reflecting mirror and said eighth plane reflecting mirror are arranged within the second fixing means, said second fixing means and said second eye lens are arranged on second mobile means, and between the first mobile means and the second mobile means is arranged a linked mechanism which moves equidistantly relative to the center. Said linked mechanism may be a crank-shaft link lever mechanism.

A first auxiliary reflecting mirror may be arranged between said first eye lens and said first reflecting mirror transferring means and a second eye lens and the second reflecting mirror transferring means. Said first eye lens and second eye lens may be an astronomical observation eye lens set.

A light splitting means can be arranged between the objective lens and the first reflecting mirror transferring means. The light path from the objective lens, after arrives at the light splitting means, divides out one path light beam which arrives at the first transferring mechanism, and divides out one path light which arrive at the third reflecting mirror transferring means. The structure and characters of the third image transferring is the same as the first reflecting mirror transferring means. The light beam which arrives at the third reflecting mirror transferring means is divided into two paths, one light path arrives at third eye lens, the other light path arrives at the fourth eye lens after passing through the four reflecting mirror transferring means.

The said light splitting means can also be divided out a light path to arrive at the fifth reflecting mirror transferring means. The structure and the characteristic of the fifth reflecting mirror transferring means is the same as the first reflecting mirror transferring means. The light beam which arrives at the fifth reflecting mirror transferring means is divided into light paths, one light path arrives at the fifth eye lens and the other beam after passing through the sixth reflecting mirror transferring means, arrives at the sixth eye lens.

As compared with the existing art, the present invention has following advantages: the reflecting mirror transferring means comprising four reflecting mirrors with angles between them is utilized to replace the reflecting mirror transferring means comprising prisms, thereby the manufacture cost is greatly reduced; the first plane reflecting mirror is arranged as a half-transmitting -and half-reflecting mirror so that it has both functions of image transferring and light splitting, thereby the structure of the product is greatly simplified, the number of components are greatly reduced. The present invention arranges a second reflecting mirror transferring means that has the same structure with the first one and an eye lens behind the half-transmitting, half-reflecting mirror, then creates a new kind of monocular telescope through which people can see objects with two eyes simultaneously. The new kind of monocular telescope has the advantages of simple product structure, low production cost, light weight and small volume, as compared with the monocular two eye telescope using prisms, the production cost of the present invention is only one tenth of the old.

The present invention is possible to be popularized and used widely. In the present invention, the angle of incidence of the plane reflecting mirror in front of eye lens can be conveniently adjusted according to the need to make the optical axis of the eye lens to be inclined by a certain angle relative to the optical axis of the objective lens. So that it can be used suitably in the application such as of a target observation telescope. With the present invention, it is also convenient to adjust the distance between the two eye lenses by means of a shifting means fixed on the crank-shaft mechanism, and to make their moving distances relative to the optical axis of the objective lens keeping equal, in the mean time to keep the optical axis remain unchanged to accommodate to people's different pupil distances. An astronomical telescope using to two eyes for observance can be constituted only by changing the objective lens and the structure little. By arranging a light splitting means on the light path behind the objective lens or other positions, a low cost telescope for simultaneous observation by multiple uses can also be constituted.

The advantages of the present invention can be also used in various optical observation equipments such as microscope etc. which need two eyes simultaneous for observation by multiple observers and which requires low product cost to be popularized and widely used.

### DESCRIPTION OF FIGURES

FIG. 1 is a schematic perspective structure view of the present invention.

FIG. 2 is a schematic view of the angle of incidence of the fourth plane reflecting mirror.

FIG. 3 is a schematic view of crank-shaft mechanism on which is fixed a shifting means.

FIG. 4 is a schematic view showing the crank-shaft mechanism on another working position.

FIG. 5 is a schematic view of the example 2 of the present invention.

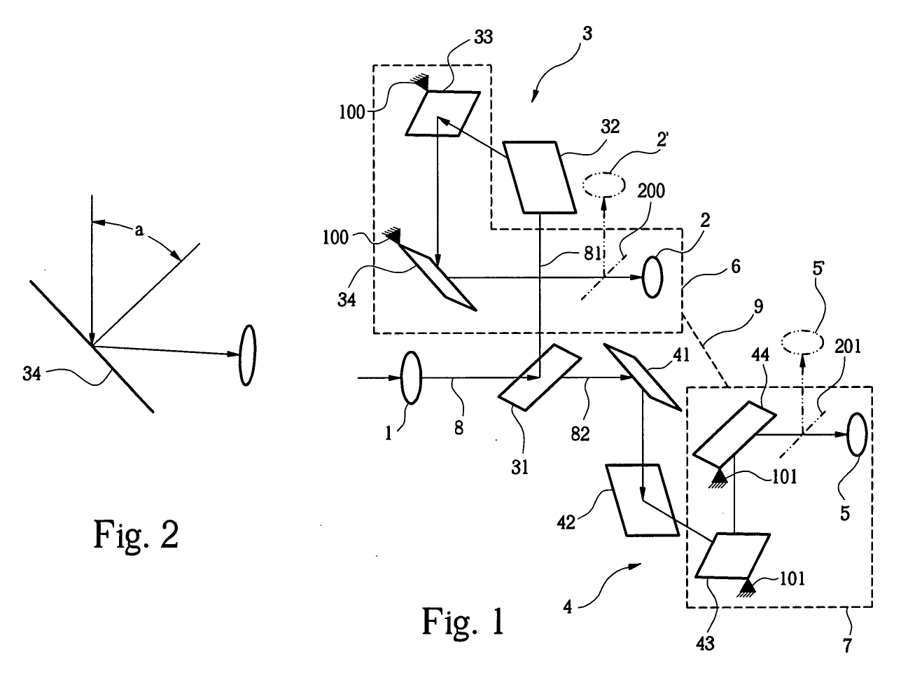

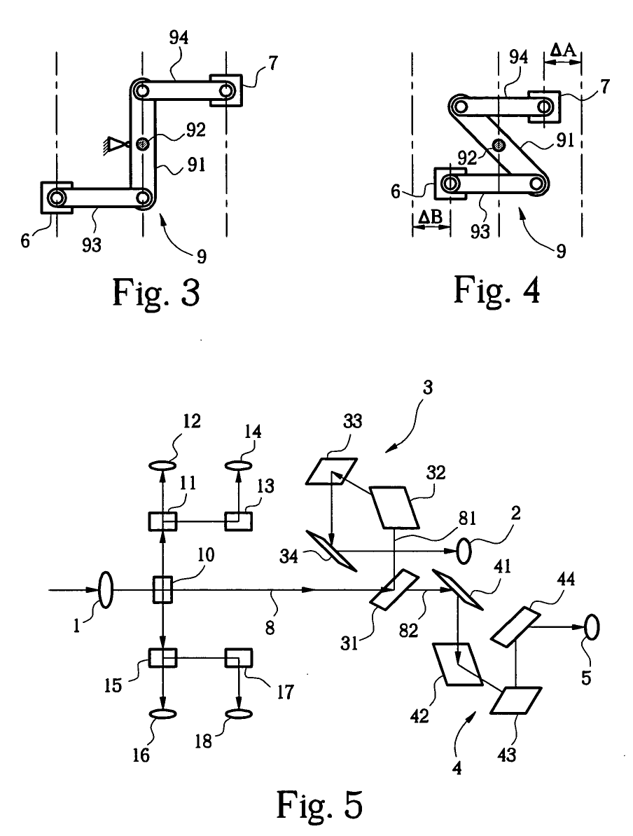

### DESCRIPTION OF THE PREFERRED EMBODIMENTS

The present invention will be described in detail the following embodiments by reference to the accompanying drawings.

### EXAMPLE 1

A binoculars having single objective lens, comprises an objective lens 1, a first eye lens 2, and a first reflecting mirror transferring means 3. The first reflecting mirror transferring means 3 includes a first planar mirror 31, a second planar mirror 32, a third planar mirror 33 and a fourth planar mirror 34. The plane of incidence of the first planar mirror 31 is perpendicular to the plane of incidence of the second planar mirror 32. The plane of incidence of the second planar mirror 32 coincides with the plane of incidence of the third planar mirror 33. The plane of incidence of the third planar mirror 33 is perpendicular to the plane of incidence of the fourth planar mirror 34. Each of the incident angles of the first, second, and third planar mirrors 31, 32, and 33 is equal to 45°, while the incident angle of the fourth planar mirror 34 is 30°. The first planar mirror is a semi-transparent, semi-reflective mirror. A second reflecting mirror transferring means 4 that is the same as the first reflecting mirror transferring means and a second eye lens 5 are arranged behind the first planar mirror 31. The second reflecting mirror transferring means 4 comprises a fifth planar mirror 41, a sixth planar mirror 42, a seventh planar mirror 43 and an eighth planar mirror 44. An optical path 8, after arriving at the first planar mirror 31, is split into a reflected light 81 and a transmitted light 82. The reflected light 81, after passing and being reflected successively by the second planar mirror 32, the third planar mirror 33 and the fourth planar mirror 34, arrives at the first eye lens 2. The transmitted light 82, after passing and being reflected successively by the fifth planar mirror 41, the sixth planar mirror 42, the seventh planar mirror 43 and the eighth planar mirror 44, arrives at the second eye lens 5. The fifth planar mirror 41 is a totally reflective mirror. The incident angle a of the eighth planar mirror 44 is the same as that of the fourth planar mirror 34, i.e. 30°. The third planar mirror 33 and the fourth planar mirror 34 are disposed within a first fixing means 100. The first fixing means 100 and the first eye lens 2 are mounted on first movable means 6. The seventh planar mirror 43 and the eighth planar mirror 44 are disposed within a second fixing means 101. The second fixing means 101 and the second eye lens 5 are mounted on second movable means 7. Between the first movable means 6 and the second movable means 7 is provided a crank shaft-link lever mechanism 9 including a central link lever 91. The central portion of the central link lever is fixed by a shaft 92 so that the central link lever 91 can swing about the shaft 92. To the two end of the central link lever 91, a left connecting bar 93 and a right connecting bar 94 with equal length are connected, respectively. The other end of each of the left connecting bar 93 and the right connecting bar 94 is respectively connected with the first movable means 6 and the second movable means 7. When the central link lever 91 swings about the shaft 92, the distance ΔA shifted relative to the center of the first movable means 6 is equal to the distance ΔB shifted relative to the center of the second movable means 7.

### EXAMPLE 2

The structure of example 2 is substantively the same as Example 1 except the following differences. A first auxiliary mirror 200 is provided between the first eye lens 2 and the first reflecting mirror transferring means 3. A second auxiliary planar mirror 201 is provided between the second eye lens 5 and the second reflecting mirror transferring means 4. The incident angle α of the fourth planar mirror 34 is 45°. The first eye lens 2′ and the second eye lens 5′ are a set of eye lens for astronomical observation.

### EXAMPLE 3

This example is substantively the same as Examples 1 and 2, except the following differences. A light splitting means 10 is provided between the objective lens 1 and the first reflecting mirror transferring means 3. The optical path 8, after passing through the objective lens 1, is split into two light beams, one light beam to the first reflecting mirror transferring means 3, and the other light beam to the third reflecting mirror transferring means 11 having the same structure and characteristic as that of the first reflecting mirror transferring means 3. The light beam which arrives at the third image transferring 11 is split into two beams, one arrives at the third eye lens 12, the other, after passing through the fourth reflecting mirror transferring means 13, arrives at the fourth eye lens 14. The light splitting means 10 also gives out a light beam to the fifth reflecting mirror transferring means 15 having the same structure and characteristic as that of the first reflecting mirror transferring means 3. The light beam which arrives at the fifth reflecting mirror transferring means 15 is split into two beams, one arrives at the fifth eye lens 16, the other, after passing through the six reflecting mirror transferring means 17, arrives at the sixth eye lens 18, thereby a binoculars having single objective lens can be used by three persons simultaneously. The light splitting means of this example can comprise different selected units so that more light beams through which objects can be seen by more individuals simultaneously are split. In this example, the incident angle α of the fourth planar mirror 34 is 60°.

### EXAMPLE 4

The structure of this example is substantively the same as the above-mentioned examples except that the incident angle α of the fourth planar mirror 34 is 15°.

### EXAMPLE 5

The structure of this example is substantially the same as the above-mentioned examples, except that the incident angle α of the fourth planar mirror 34 is 75°.

Although the description above contains much specificity, these should not be construed as limiting the scope of the invention but as merely providing illustrations of some of the presently preferred embodiments of this invention. Thus the scope of the invention should be determined by the appended claims and their legal equivalents, rather than by the examples given.

I claim:

1. A binoculars having single objective lens including:
an objective lens;
a first eye lens;
a first reflecting mirror transferring means for transferring the objective image to said first eye lens and to a second reflecting mirror transferring means;
a second eye lens;
said second reflecting mirror transferring means for transferring the objective image received from said first reflecting mirror transferring means to said second eye lens.

2. The binoculars of claim 1 wherein:
said first reflecting mirror transferring means comprises a first planar mirror, a second planar mirror, a third planar mirror, and a fourth planar mirror;
said second reflecting mirror transferring means comprises a fifth planar mirror, a sixth planar mirror, a seventh planar mirror and an eighth planar mirror.

3. The binoculars of claim 2 wherein:
said first planar mirror is a semi-transparent semi-reflective mirror, said second reflecting mirror transferring means is positioned behind said first planar mirror, and receives the object image passing through said first planar mirror.

4. The binoculars of claim 2 wherein:
the plane of incidence of said first planar mirror is perpendicular to the plane of incidence of said second planar mirror, the plane of incidence of said second planar mirror coincides with the plane of incidence of said third planar mirror, and the plane of incidence of the third planar mirror is perpendicular to the plane of incidence of said fourth planar mirror; and
each of the incident angles of said first planar mirror, said second planar mirror and said third planar mirror is equal to 45°;
the angle of incidence of said fourth planar mirror is 15°˜75°.

5. The binoculars of claim 4 wherein the angle of incidence of said fourth planar mirror is 30°.

6. The binoculars of claim 4 wherein the incident angle of said eighth planar mirror is equal to the reflecting angle of said fourth planar mirror.

7. The binoculars of claim 2 further comprising a link means for adjusting the distance between said first and second eye lenses for different people.

8. The binoculars of claim 7 wherein said link means is a crankshaft-link lever means.

9. The binoculars of claim 7 wherein said third planar mirror and said fourth planar mirror are disposed within a first fixing means, said first fixing means and said first eye lens are mounted on a first movable means; said seventh planar mirror and said eighth planar mirror are disposed within a second fixing means; said second fixing means and said second eye lens are mounted on a second movable means; said linking means is arranged between said first movable means and said second movable means; and said linking means moves equidistantly relative to its center.

10. The binoculars of claim 1 wherein a first auxiliary planar mirror is provided between said first eye lens and said first reflecting mirror transferring means; a second auxiliary planar mirror is provided between said second eye lens and said second reflecting mirror transferring means; said first eye lens and said second eye lens are a set of astronomical observation eye lens.

11. The binoculars of claim 1 wherein a light splitting means is provided between said objective lens and said first reflecting mirror transferring means, a light path from said objective lens is split into two light beams by said light splitting means, a first and/or second binoculars having single objective lens are/is optically connected to said two light beams respectively.

12. The binoculars of claim 2 wherein a light splitting means is provided between said objective lens and said first reflecting mirror transferring means, a light path from said objective lens is split into two light beams by said light splitting means, a first and/or second binoculars having single objective lens are/is optically connected to said two light beams respectively.

13 The binoculars of claim 3 wherein a light splitting means is provided between said objective lens and said first reflecting mirror transferring means, a light path from said objective lens is split into two light beams by said light splitting means, a first and/or second binoculars having single objective lens are/is optically connected to said two light beams respectively.

14. The binoculars of claim 2 wherein an optical path, after passing through said objective lens, and being successively reflected by said first planar mirror,
said second planar reflecting mirror, said third planar mirror, and said fourth planar mirror, arrives at said first eye lens;
the plane of incidence of said first planar mirror is perpendicular to the plane of incidence of said second planar mirror, the plane of incidence of said second planar mirror coincides with the plane of incidence of said third planar mirror, and the plane of incidence of said third planar mirror is perpendicular to the plane of incidence of said fourth planar mirror; and
each of the incident angles of said first planar mirror, said second planar mirror and said third planar mirror is equal to 45°;
said first planar mirror is a semi-transparent semi-reflective mirror, behind said first planar mirror are arranged said second reflecting mirror transferring means having the same structure as that of said first reflecting mirror transferring means and a second eye lens;
the optical path, after arriving at said first planar mirror, is split into a reflected light and a transmitted light; said reflected light arrives at said first eye lens; said transmitted light, after passing through said second reflecting mirror transferring means, arrives at said second eye lens; and
the angle of incidence of said fourth planar mirror is 15°˜75°.

15. The binoculars of claim 2 wherein a transmitted light beam, after being respectively reflected by said fifth planar mirror, said sixth planar mirror, said seventh planar mirror and said eighth planar mirror, arrives at said second eye lens, said fifth planar mirror is a totally reflective mirror, and the incident angle of said eighth planar mirror is equal to the reflecting angle of said fourth planar mirror.
